(19) United States
(12) Patent Application Publication
(10) Pub. No.: US 2009/0197513 A1
(43) Pub. Date: Aug. 6, 2009

(54) PROCESSING A FLEXOGRAPHIC PRINTING PLATE

(75) Inventors: Martin Philip GOUCH, Hemel Hempstead (GB); Christoph BITTNER, Hemel Hempstead (GB)

Correspondence Address: KENYON & KENYON LLP, RIVERPARK TOWERS, SUITE 600, 333 W. SAN CARLOS ST., SAN JOSE, CA, 95110, US

(73) Assignee: FFEI LIMITED, Hertfordshire (GB)

(21) Appl. No.: 12/024,091

(22) Filed: Jan. 31, 2008

(51) Int. Cl. B24B 1/00; B28B 11/08; B24B 19/22; B28B 1/00

(52) U.S. Cl. 451/54; 264/293; 425/470; 451/178; 451/213

(57) ABSTRACT

A method for processing a flexographic printing plate on which patterned flexographic material that is uncured or partially cured has been provided, the method comprising mechanically shaping the upper surface of the flexographic material and fully curing the shaped material.

### FIELD OF THE INVENTION

The invention relates to methods and apparatus for processing a flexographic printing plate.

### DESCRIPTION OF THE PRIOR ART

Flexographic printing plates are used widely in letter press printing and the like, particularly for printing on surfaces which are soft and easily deformable such as packaging materials. The plates are typically prepared from photopolymerisable compositions comprising an elastomeric binder, at least one monomer and a photo-initiator.

The manufacture of flexographic plates is a relatively slow process since it involves several manufacturing stages. A plate is typically made from three layers. A UV transparent support layer, a layer of uncured flexographic material such as rubber, and an upper light sensitive UV mask material. The light sensitive UV mask is exposed to UV-A irradiation with the print image required, and developed. Then the flexographic material is exposed with UV-A Light from the rear and above to cure the areas that need to be retained. The mask material and the unexposed flexographic material is then removed with a washing, etching or erosion process. Then the remaining flexographic material is first dried and then hardened with the exposure of more UV-A and finally UV-C radiation.

US-A-2004/0131778 incorporated herein by reference describes a method of depositing flexographic material using an inkjet printer and using UV pin curing to hold the desired shape. Pin curing is defined herein as sufficiently curing the material to immobilise it on the underlying surface but without necessarily fully curing the material.

This recently developed approach enables the flexographic plate to be produced in fewer stages and with much less wastage of material. In this process, the flexographic plate is built up by printing successive layers of the flexographic material, each layer being partially cured or pin cured to hold its shape prior to receiving the next layer and so that it is able to be wetted by the next layer. Typically, for a 0.5 mm relief height, about 60 layers of ink will need to be printed.

In our copending application of even date entitled “Producing a flexographic printing plate” we describe a method of producing a flexographic printing plate comprising:
a) inkjet printing a layer of flexographic material in a predetermined pattern onto a substrate;
b) partially curing at least part of the printed layer of flexographic material so as to immobilise it on the substrate; and
c) repeating steps (a) and (b) so as to print and partially cure one or more further layers of flexographic material in the predetermined pattern on the previous layer(s),

characterised by additionally curing one or more lower printed layers before or while printing one or more upper layers so as to reduce spreading of the lower printed layer(s).

We also describe an apparatus for producing a flexographic printing plate comprising an inkjet printer adapted to pint flexographic material in a predetermined pattern onto a substrate and on to previously printed flexographic material;

a substrate support;

a system for causing relative movement between the inkjet printer and the substrate support;

a first curing system for partially curing part of each printed layer of flexographic material so as to immobilise it; and

a second curing system for additionally curing one or more lower printed layers before or while printing upper layers so as to reduce spreading of the lower printed layers.

The finished form of the raised portions of the flexographic printing plate is important to achieve a high quality printed image in use. An important aspect of the finished form is the shape of the upwardly facing surface of each dot or other feature on the plate. US-A-2004/0131778 describes a method for improving the surface quality by depositing small drops of flexographic material on to the surface. However, this requires additional material and accurate printing resolution.

### SUMMARY OF THE INVENTION

In accordance with a first aspect of the present invention, a method for processing a flexographic printing plate on which patterned flexographic material that is uncured or partially cured has been provided comprises mechanically shaping the upper surface of the flexographic material and fully curing the shaped material.

In accordance with a second aspect of the present invention, apparatus for processing a flexographic printing plate on which patterned flexographic material that is uncured or partially cured has been provided comprises a shaping system for mechanically shaping the upper surface of the flexographic material; and a curing system for fully curing the material.

The mechanical shaping can take a variety of forms such as abrading, polishing and pressing and can be achieved by various different shaping components including rotating cylinders or rollers and flat sheets.

Curing can take place during or after the shaping step and it is particularly convenient if the shaping component is transparent to curing radiation since this results in a much more compact apparatus and the ability to cure that portion of the flexographic material which remains uncured during the shaping process.

This provides a much simpler approach to solving the problem and can be achieved using a variety of techniques including abrading, rolling and polishing.

### BRIEF DESCRIPTION OF THE DRAWINGS

Some examples of methods and apparatus according to the invention will now be described with reference to the accompanying drawings, in which:

FIG. 1 is a schematic side view of an example of apparatus for producing a flexographic printing plate; and,

FIGS. 2-7 illustrate schematically different methods and apparatus for mechanically shaping the upwardly facing surface of a previously deposited flexographic material.

### DETAILED DESCRIPTION OF THE EMBODIMENTS

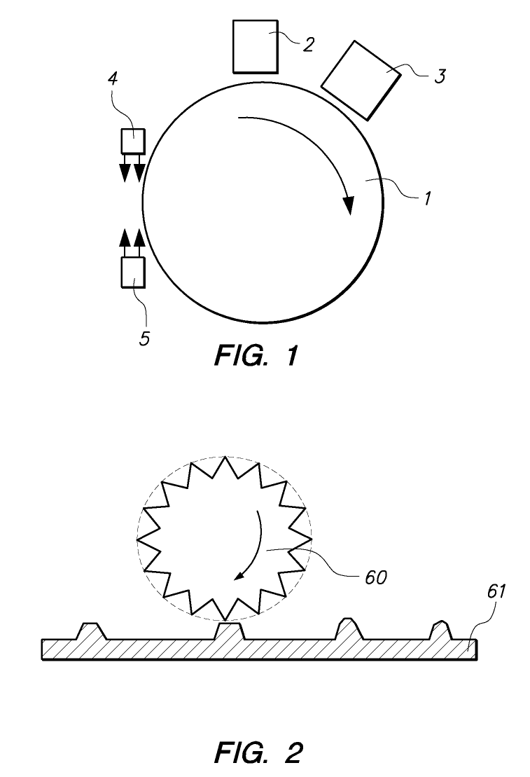

The invention can be applied to flexographic printing plates made by many different techniques. One example is shown in FIG. 1. A rotatably mounted drum 1 is provided on which a printing plate (not shown) is mounted in use. The drum rotates in a clockwise direction in use so as to cause the plate to pass firstly under an inkjet printer 2 having an inkjet print bar which is controlled to print a flexographic material in a predetermined pattern on to the plate; and then under a pin curing device 3, typically a source of UV-C radiation. Further rotation of the drum 1 brings the plate into the vicinity of further UV-C sources 4, 5 which are arranged, as explained below, to irradiate sides of the material printed by the inkjet printer 2 so as to additionally cure the side walls. The drum 1 then further rotates to bring the plate back under the inkjet printer 2 to enable a further layer of flexographic material to be printed on to the previously printed layer. This process continues until the plate has been fully printed at which point it is detached from the drum 1 and conveyed to a final curing station where it is irradiated with UV-A (and optionally UV-C) to fully cure the deposited material.

As explained above, the sources 4, 5 are used to provide an additional curing stage which irradiates primarily the side of the built up material. In the first few layers this is not required as the normal pinning or immobilising stage will halt the flow of flexographic material but after a small number of layers have been deposited this additional stage is introduced which primarily radiates the sides of the built up material thus curing them further enabling them to support the mass of the material deposited above them. This can be performed with one or more collimated UV light sources 4, 5 or from a light bar or an array of collimated UV LED's. With a collimated source the strength of radiation is proportional the cosine of the angle of the incident surface to the beam axis. Thus if the collimated source had an glancing angle of 5 deg then the top surface would receive only 9% of the radiation per unit area and a 30 degree to the normal wall would receive 90% of the radiation per unit area, almost 10 times as much radiation. To produce side wall hardening in all directions typically four directions would need to be illuminated. This would give the top surface four times as much radiation per unit area giving a radiation 2.5× to the side walls. However, the top surface would only receive it's radiation once (because it all be covered by the next deposited layer) and the side walls would receive their radiation every time the radiation was applied on successive layers. The lower layers may receive this side wall hardening 100 times. Thus this side wall hardening radiation need only be at a low level as the build up over all the layers gradually hardens the lower levels as is desired.

In a typical plate, the flexographic material will define a dot pattern with dot heights in the order of 0.5 mm and a spacing between dots of 100 μm.

The inkjet printer 2 and pin curing device 3 can be of conventional form as for example described in US-A-2004/0131778.

The flexographic material can also be of any conventional form. Examples of suitable compositions include

monomer/oligomer component, e.g. pentaerythritol triacrylate, isobornylacrylate, triethyleenglycoldivinylether

photoinitiator component, e.g. Genocure DEAP (Rahn), Irgacure 819 (Ciba-Geigy)

Inhibitor component, 2-methyl hydrochinon

Placticizer component, e.g. Sant5icizer 278 (Monsanto)

Elastomers binder, e.g. Cariflex TR226, Hycar1022 (Goodrich).

Other methods are described in our copending patent application referred to above.

We now consider how to improve the form of the upwardly facing surface of the printed flexographic material.

To avoid the effect of a non-flat surface caused by the meniscus of the flexographic material it is desirable to flatten the printed surface to create a more plateaux type surface. As at least the most recently printed flexographic material is not fully cured and has only been pin cured it is still soft and can be moulded, cut or eroded into the desired plateau shape.

In one embodiment (FIG. 2) the plateau shape can be eroded onto the flexographic material with a rotating abrasive cylinder 60 having radically outwardly projecting teeth and which is held at the desired height above the plate 61. Material above the desired height is then removed by the abrasive cylinder. The remaining flexographic material is then fully cured with UV-A and UV-C radiation.

In this example, the plate 61 is held stationary while the cylinder 60 rotates and when the desired shaping has been completed, the plate 61 is moved to bring the next part of the flexographic material into line with the cylinder for shaping.

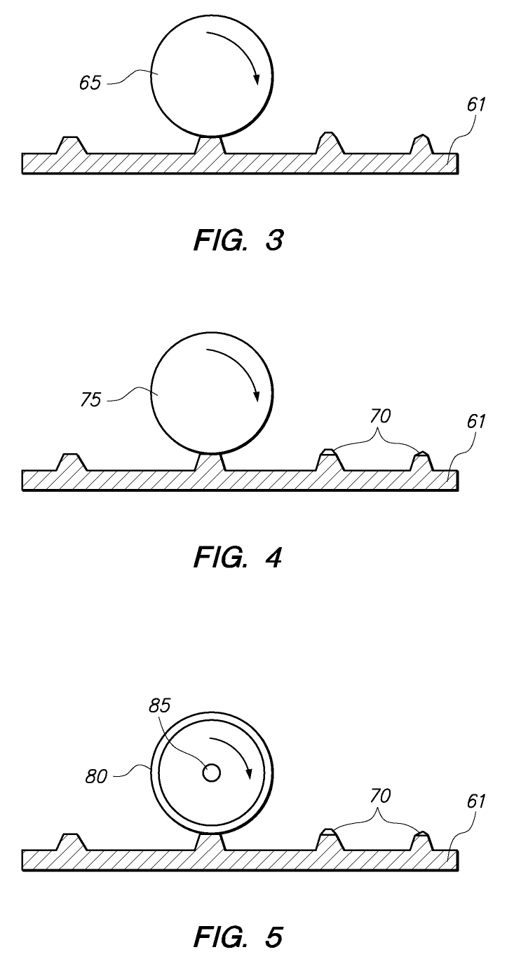

In another embodiment (FIG. 3) the desired plateau shape is pressed onto the flexographic material by a polished cylinder 65 held at the desired height. As the flexographic material is partially cured the plateau shape is retained on contact with the cylinder. The remaining flexographic material is then fully cured with UV-A and UV-C radiation.

In this case, the plate 61 is moved laterally during the polishing process while the cylinder 65 is rotated so that its peripheral speed matches that of the plate 61.

In an alternative to the FIG. 3 example, the polished cylinder 65 is rotated such that its peripheral speed is faster than the speed of movement of the plate 61.

In the FIG. 4 example the final layer or layers of flexographic material 70 are either not pin cured or only slightly pin cured and then passed under a heated polished cylinder 75 held at the desired height. The heat then cures the flexographic material while it is held in the correct shape and ensures that the flexographic material obtains its shape. The cylinder 75 can be rotated with a peripheral speed which matches or is faster than the lateral speed of movement of the plate 61.

In the FIG. 5 example, a polished cylinder 80 is provided which is transparent to UV radiation and the UV-A light source 85 is located within the cylinder 80. The cylinder 80 is rotated so that its peripheral surface speed matches or alternatively faster than the speed of movement of the plate 61. The final layers 70 of flexographic material which have not been pin cured or slightly pin cured are then both then cured by radiation and polished to the desired shape.

In a modification of FIG. 5, the transparent cylinder could also be heated.

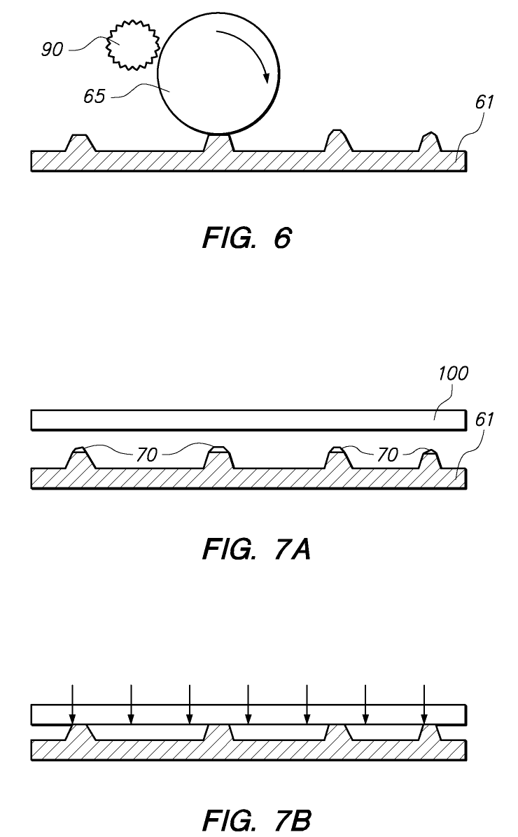

In all the examples described with reference to FIGS. 2 to 5, the cylinder can be continuously cleaned whilst it is not in contact with the flexographic material, as shown in FIG. 6. In that case, a cleaning roller 90 is located adjacent to the surface of the cylinder 65 and is rotated in the same or opposite sense to the cylinder 65 such that its peripheral speed is different from that of the cylinder 65 and thus any flexographic material adhering to the cylinder 65 is removed.

FIG. 7 illustrates another embodiment for shaping the flexographic material. In this case, as in some of the previous examples, the last layer or layers of the flexographic material are not pin cured or are only partially pin cured as shown at 70 (FIG. 7a).

A flat sheet 100 of transparent material, such as borosilicate float glass, is then brought into contact with, and held at the desired distance from, the flexographic plate 61, to force the plateau shape, and UV-A light is transmitted through the transparent sheet 100 to partially cure the flexographic material so it will hold it's shape when the sheet of glass is removed (FIG. 7b). The remaining flexographic material is then fully cured with UV-C radiation.

In a modification of the FIG. 7 example, the sheet 100 could be replaced by a heated, polished sheet. The heat from the polished sheet then cures the non or partially pin cured flexographic material.

In the embodiments utilising a flat sheet, a defined pattern could be embossed on the sheet face if a non-polished finish is desired.

We claim:

1. A method for processing a flexographic printing plate on which patterned flexographic material that is uncured or partially cured has been provided, the method comprising:
mechanically shaping the upper surface of the flexographic material; and
fully curing the shaped material.

2. A method according to claim 1, wherein the shaping step comprises one of abrading, polishing and pressing.

3. A method according to claim 1, wherein shaping comprises flattening.

4. A method according to claim 1, further comprising at least partially curing the flexographic material while carrying out the shaping step.

5. A method according to claim 4, wherein the step of fully curing the material takes place after the shaping step has been completed.

6. A method according to claim 1, wherein the shaping step is carried out by causing relative movement between a shaping surface and the upper surface of the flexographic material.

7. A method according to claim 1, wherein the shaping step is carried out by pressing a heated shaping surface onto the flexographic material, the heat causing the material at least partially to cure.

8. A method according to claim 1, wherein the shaping step is carried out while irradiating the material with curing radiation.

9. A method according to claim 8, wherein the curing radiation passes through a shaping surface in contact with the material so as to impinge on the flexographic material.

10. An apparatus for processing a flexographic printing plate on which patterned flexographic material that is uncured or partially cured has been provided, the apparatus comprising a shaping system for mechanically shaping the upper surface of the flexographic material; and a curing system for fully curing the material.

11. An apparatus according to claim 10, wherein the shaping system comprises a shaping component in the form of a rotatably mounted cylinder.

12. An apparatus according to claim 11, further comprising a system for causing lateral movement of the printing plate, the peripheral speed of the cylinder being faster than the plate lateral movement.

13. An apparatus according to claim 11, further comprising a system for causing lateral movement of the printing plate, the peripheral speed of the cylinder being the same as the plate lateral movement.

14. An apparatus according to claim 10, wherein the shaping system comprises a shaping component with one of an abrading or polished surface.

15. An apparatus according to claim 12, wherein the surface of the shaping component has an array of abrading teeth.

16. An apparatus according to claim 11, further comprising a cleaning roller rotatably mounted in engagement with the rotatably mounted cylinder.

17. An apparatus according to claim 10, wherein the shaping system comprises a shaping component which is transmissive to curing radiation, the curing system including a radiation source for generating curing radiation that passes through the shaping component.

18. An apparatus according to claim 10, wherein the shaping system comprises a shaping component in the form of a planar, pressure plate.
